(19) United States
(12) Patent Application Publication
(10) Pub. No.: US 2005/0129060 A1
(43) Pub. Date: Jun. 16, 2005

(54) [METHOD OF SETTING OPERATION CHANNELS OF WIRELESS LOCAL AREA NETWORK ACCESS POINT]

(76) Inventor: Chen-Hua Pang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,643

(22) Filed: Mar. 17, 2004

(30) Foreign Application Priority Data
Dec. 10, 2003 (TW) 92134785

(51) Int. Cl. H04J 3/16

(52) U.S. Cl. 370/468

(57) ABSTRACT

A method of setting operation channels of a local area network access point is provided. First, the occupation status of various channels is obtained. Each channel is divided into a plurality of sub-channels. An in-use weight of each sub-channel is computed, and the channel having the most unused sub-channels or the least total in-use weight is selected as the operation channel of the local area network access point.

### CROSS REFERENCE TO RELATED APPLICATIONS

This application claims the priority benefit of Taiwan application serial no. 92134785, filed Dec. 10, 2003.

### BACKGROUND OF INVENTION

1. Field of the Invention

The present invention relates to a wireless local area network. More particularly, the present invention relates to a method of setting operation channels of a wireless local area network access point.

2. Description of the Related Art

Due to the need to exchange information between different locations, networks have become an indispensable transmission medium. In the networking world, wire-less local area networks has become an alternative means of network connection besides the cable network.

FIG. 1 is a table listing out all the wireless local area network channels assigned by IEEE 802.11b-1999. In the table, the CHNL_ID field represents the channel code, the frequency field represents the central frequency of the channel and the remaining fields represent the channel setup status at various places. For example, the FCC field indicates that channel 1 to channel 11 are used in North America and the ETSI field indicates channel 1 to channel 13 are used in Europe (except France and Spain). Although the central frequency of various channels is different, a portion of the frequency range of some of the channels may overlap due to frequency expansion. In other words, a certain degree of interference may occur between neighboring channels. Yet, in the past, the operation channels of the wireless local area network access point are often randomly selected by the user. If the user is unaware of any channel interference problem, the quality of communication using the wireless local area network will drop.

### SUMMARY OF INVENTION

Accordingly, one objective of the present invention is to provide a method of setting operation channels of a wire-less local area network access point. The operation channels of the wireless local area network access point are selected according to the occupation status of various neighboring channels.

To achieve these and other advantages and in accordance with the purpose of the invention, as embodied and broadly described herein, the invention provides a method of setting operation channels of a wireless local area network access point. First, the occupation status of various channels is obtained. Each channel is divided into a plurality of sub-channels. An in-use weight of each sub-channel is computed according to the usage condition of various channels, and the channel having the most unused or unoccupied sub-channels is selected as the operation channel of the local area network access point.

The occupation status of various channels can be obtained by scanning with a wireless local area network card, for example.

The number of sub-channels in each channel can be set according to demand.

The present invention also provides an alternative method of setting operation channels of a wireless local area network access point. First, the occupation status of various channels is obtained. Each channel is divided into a plurality of sub-channels. An in-use weight of each sub-channel is computed according to the usage condition of various channels, and the channel having the least total in-use weight is selected as the operation channel of the local area network access point.

The occupation status of various channels can be obtained by scanning with a wireless local area network card, for example.

The number of sub-channels in each channel can be set according to demand.

In brief, the method of the present invention allows access to the best operation channels of a wireless local area network by selecting the channel having least in-use or occupation load as the operation channels relative to the occupation status of various neighboring channels. Accordingly, inter-channel interference can be substantially reduced and the performance of the network communication can be substantially improved.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a table listing out all the wireless local area network channels assigned by IEEE 802.11b-1999.

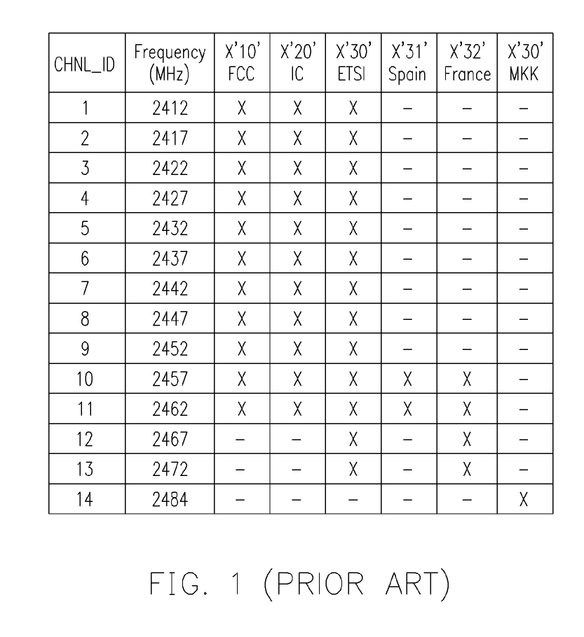

FIG. 2 is a diagram showing proposed operation channels for the North American region.

FIG. 3 is a diagram showing proposed operation channels for the European region (except France and Spain).

FIG. 4 is a flow-chart showing the programming steps according to one preferred embodiment of this invention.

FIG. 5 is an example showing the assignment of operation channels to a wireless local area network access point.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Because the operation channels of the wireless local area network access point are used to be randomly selected by the user, communication quality through the wireless local area network is often low if the user is unaware of any channel interference problem. To prevent such interference problems, the present invention provide a method of setting operation channels of a wireless local area network access point to improve communication network performance. The method of the present invention includes selecting operation channels according to the occupation status of neighboring wireless local area network access point channels.

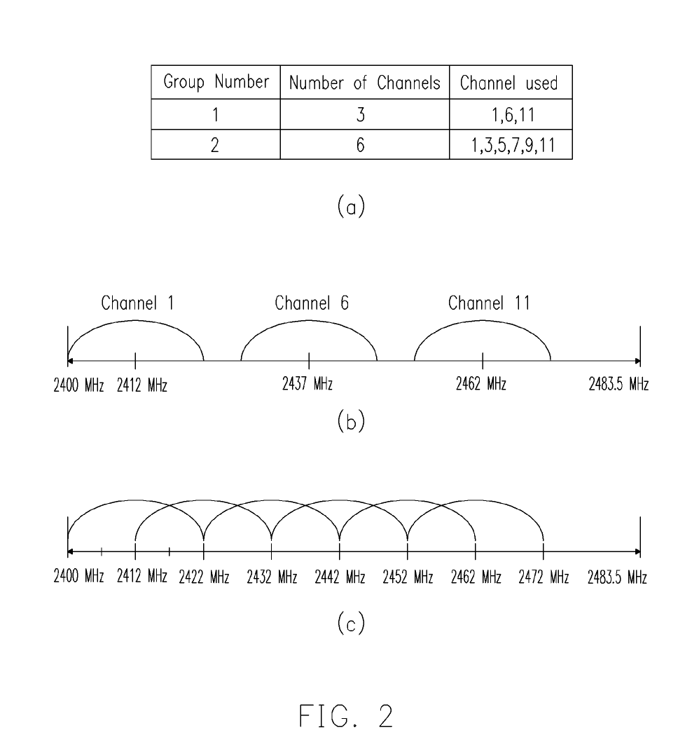

FIG. 2 is a diagram showing proposed operation channels for the North American region. FIG. 2(a) shows two different groups of channels. In the first group, a total of three channels are being proposed to constitute channel 1, channel 6 and channel 11. In the second group, a total of six channels are being proposed to constitute channel 1, channel 3, channel 5, channel 7, channel 9 and channel 11. The frequency ranges of various channels within the two groups are showing in FIG. 2(b) and FIG. 2(c) respectively. In FIG. 2(b), there is no overlapping of frequencies between the channels. However, in FIG. 2(c), some of the channels are shown to have overlapping frequencies.

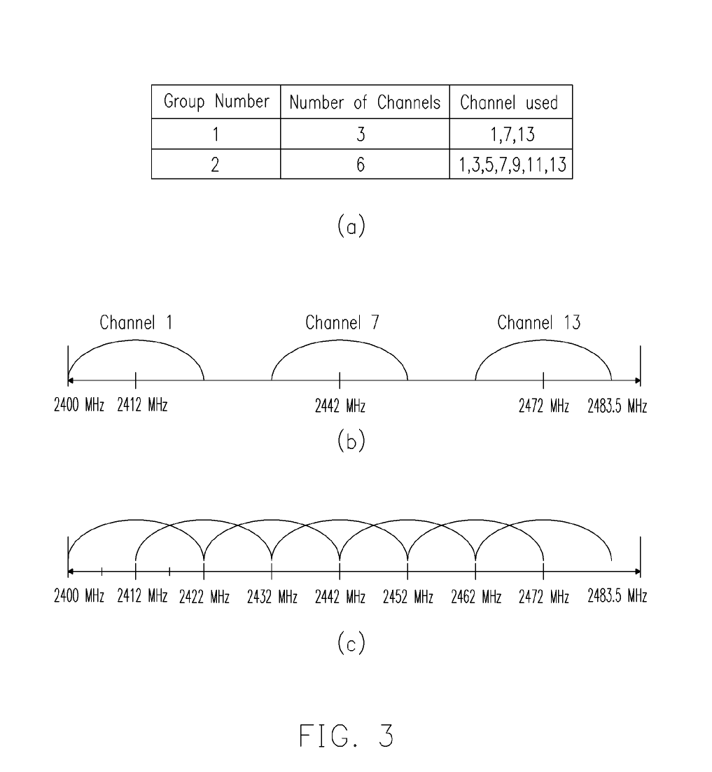

FIG. 3 is a diagram showing proposed operation channels for the European region (except France and Spain). FIG. 3(a) shows two different groups of channels. In the first group, a total of three channels are being proposed to constitute channel 1, channel 7 and channel 13. In the second group, a total of seven channels are being proposed to constitute channel 1, channel 3, channel 5, channel 7, channel 9, channel 11 and channel 13. The frequency ranges of various channels within the two groups are showing in FIG. 3(b) and FIG. 3(c) respectively. In FIG. 3(b), there is no overlapping of frequencies between the channels. However, in FIG. 3(c), some of the channels are shown to have overlapping frequencies.

Based on the proposed channels shown in FIGS. 2 and 3, a program capable of finding the preferred operation channels for the North American region with minimum frequency overlapping is written as follows.

| | |
|---|---|
| 0001: | Example Program: |
| 0002: | #define MAX_C 11 |
| 0003: | #define SUB_BW 4 |
| 0004: | #define OFFSET_SUBCHANNEL 1 |
| 0005: | #deflne SUB_CNT |

(MAX_C+SUB_BW-OFFSET_SUBCHANNEL)
0006:

| | |
|---|---|
| 0007: | int channel[14]={ 0, 0, 0, 1, 1, 0, 0, 0, 0, 0, 0, 0, 0, 0}; |
| 0008: | int SubChannel[SUB_CNT], FreeSub[MAX_C], SumChannel[MAX C]; |
| 0009: | int i,j; |
| 0010: | int MaxFree, MinUsage, MaxFreeIdx, MinUsageIdx; |
| 0011: | |
| 0012: | for (i=0; i < SUB_CNT; i++) SubChannel[i] =0; |
| 0013: | for (i = 0; i < MAX_C; i++) FreeSub[i] = SumChannel[i] =0; |
| 0014: | printf(“Calculate subchannel information.\n”); |
| 0015: | for (i = 0; i < MAX_C; i++) { |

| | |
|---|---|
| 0016: | for(j = i;j<(i + SUB_BW);j++) |
| 0017: | SubChannel[j] += channel[i]; |

| | |
|---|---|
| 0018: | } |
| 0019: | for (i = 0; i < SUB_CNT, i++) printf(“SubChannel %02d usage = %d \n”, i, |

SubChannel[i]);

| | |
|---|---|
| 0020: | for (i = 0; i < MAX_C; i++) |

| | |
|---|---|
| 0021: | for(j = 0;j < SUB_BW;j++) { |

| | |
|---|---|
| 0022: | if(SubChannel[i +j] == 0) FreeSub[i]++; |
| 0023: | SumChannel[i] += SubChannel[i +j]; |

| | |
|---|---|
| 0024: | } |

| | |
|---|---|
| 0025: | MaxFree = 0; // record the couut of max free |
| 0026: | MinUsage = 0xff, // record the count of min usage |
| 0027: | MaxFreeIdx =− 1; // record the index of max free channel |
| 0028: | MinUsageIdx =− 1; // record the index of min usage channel |
| 0029: | for (i = 0; I<MAX_C; i++) { |

| | |
|---|---|
| 0030: | printf(“Channel %02d free count is %d\n”, i +1, FreeSub[i]); |
| 0031: | printf(“Channel %2d weight usage is %d\n”, i + 1, SumChannel[i]); |
| 0032: | if(FreeSub[i] > MaxFree) { |

| | |
|---|---|
| 0033: | MaxFree = FreeSub[i]; |
| 0034: | MaxFreeIdx = i; |

| | |
|---|---|
| 0035: | } |
| 0036: | if(SumChannel[i] < MinUsage) { |

| | |
|---|---|
| 0037: | MinUsage = SumChannel[i]; |
| 0038: | MinUsageIdx = i; |

| | |
|---|---|
| 0039: | } |

| | |
|---|---|
| 0040: | } |
| 0041: | // policy 2.0 max free subchannel is the best channel |
| 0042: | for (i = 0; i < MAX_C; i++) { |

| | |
|---|---|
| 0043: | if(FreeSub[i] >− MaxFree) |
| 0044: | printf(“Max free channel is %d, the free count = %d\n, i + 1, FreeSub[i]); |

| | |
|---|---|
| 0045: | } |
| 0046: | //policy 2.1 min weight of usage is best |
| 0047: | for (i = 0; i < MAX_C; i++) { |

| | |
|---|---|
| 0048: | if(SumChannel[i] <= MinUsage) |
| 0049: | printf(“Min Usage channel is %d, the Usage count = %d\n“, i + 1; |

MinUsage);

| | |
|---|---|
| 0050: | } |
| 0051: | |

In the aforementioned program, the constant MAX_C is set to 11 and the constant SUB_BW is set to 4. In other words, the number of usable channels in North American region is 11. Furthermore, each channel is further divided into four sub-channels and the in-use weight of each sub-channel in various channels is computed, and the channel with the most unused or unoccupied sub-channels or the least total in-use weight is selected as the operation channel of the wireless local area network access point.

For example, the frequency range of the first channel is between 2400 MHz and 2424 MHz. When channel 1 is divided into four sub-channels, sub-channel 1 occupies the frequency range between 2400 MHz and 2406 MHz, sub-channel 2 occupies the frequency range between 2406 MHz and 2412 MHz, sub-channel 3 occupies a frequency range between 2412 MHz and 2418 MHz and sub-channel 4 occupies a frequency range between 2418 MHz and 2424 MHz. Because sub-channel 1 will not overlap with other channels, a 1 (one) is added to the in-use weight only when channel 1 is in use. On the other hand, sub-channel 2 overlaps with channel 2, a 1 (one) is added to the respective in-use weight when channel 1 or channel 2 are in use. Similarly, sub-channel 3 overlaps with channel 2 and channel 3, a 1 (one) is added to the respective in-use weight when channel 1, channel 2 or channel 3 are in use. Finally, sub-channel 4 overlaps with channel 2, channel 3 and channel 4, a 1 (one) is added to the respective in-use weight when channel 1, channel 2, channel 3 or channel 4 are in use. Obviously, the overlapping condition of channels can be more accurately determined. In other words, this technique allows setting a number of sub-channels on demand.

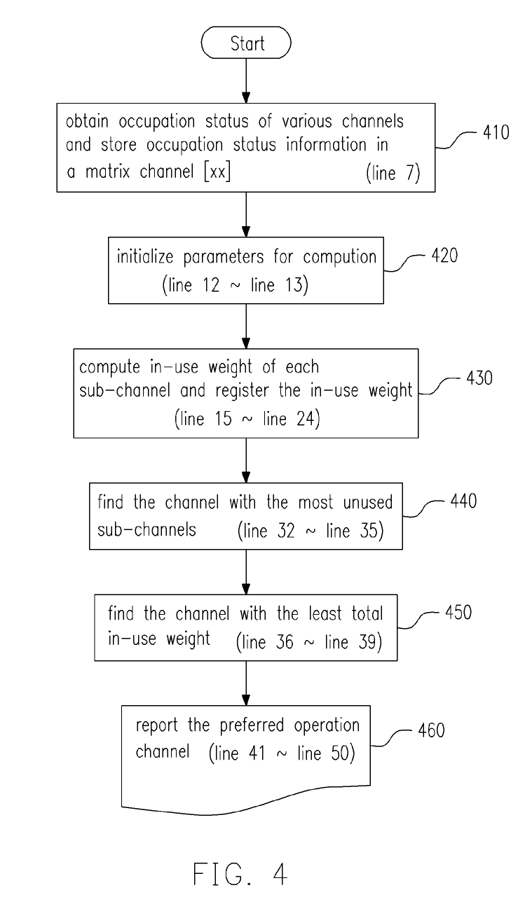

FIG. 4 is a flow-chart showing the programming steps according to one preferred embodiment of this invention. In step 410, a wireless local area network card is used to scan and obtain the occupation status of various channels as shown in line 7 of the program. The occupation status information of the channels is stored in a channel [ ] matrix. Thereafter, in step 420, the parameters needed for carrying out the computation are initialized in lines 12 and 13 of the program. In step 430, in-use weights of sub-channels are computed according to the status of various channels as shown in lines 15 to 24 of the program. In step 440, the channel with the most unused sub-channels is singled out using lines 32 to 35 of the program. Alternatively, in step 450, the channel with the least total in-use weight is singled out using lines 36 to 39 of the program. In step 460, the channel having the most unused sub-channels (sub-channels having an in-use weight of 0) or the channel with the least total in-use weight is reported through lines 41 to 50 in the program. Ultimately, the optimized channel is chosen as the operation channel of the newly added wireless local area network access point.

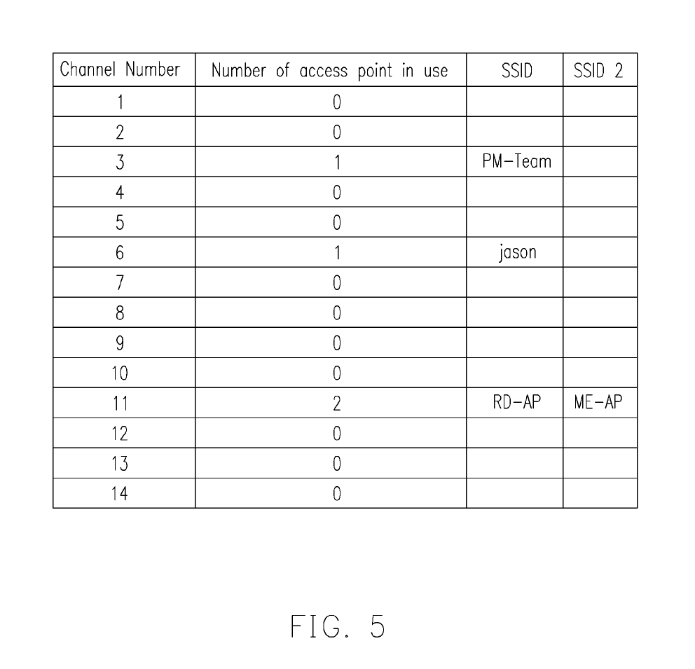

FIG. 5 is an example showing the assignment of operation channels to a wireless local area network access point. In FIG. 5, fields SSID and SSID2 are names identifying the wireless local area network access points. In the table, the wireless local area network access point with the name jason is set to channel 6. Similarly, the wireless local area network access points with the names RD-AP and ME-AP are set to channel 11. A new wireless local area network access point with the name PM-Team is randomly set to channel 3 by the user. Because channel 6 has already been used, the random setting of the wireless local area network access point by the name PM-Team to channel 3 may result in a certain degree of frequency interference and a little drop in network communication performance. However, using the method of the present invention, the new PM-Team wireless local area network access point is set to operate on channel 1 whether the selection is based on the most unused sub-channels or the least total in-use weight.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of setting operation channel of wireless local area network access point, comprising the steps of:
obtaining the occupation status of various channels in the surrounding;
dividing each channel into a plurality of sub-channels and computing to determine in-use weight of each sub-channel according to the occupation status of the channels; and
selecting the channel with the most unoccupied sub-channels to serve as an operation channel of the wire-less local area network access point.

2. The method of claim 1, wherein the usage status of various channels is obtained by scanning the surrounding channels with a wireless local area network card.

3. The method of claim 1, wherein the number of sub-channels in each channel is set according to a demand.

4. A method of setting operation channel of wireless local area network access point, comprising the steps of:
obtaining the occupation status of various channels in a region surrounding respective channels;
dividing each channel into a plurality of sub-channels and computing to determine an in-use weight of each sub-channel according to the occupation status of the channels; and
selecting the channel with a least total in-use weight to serve as an operation channel of the wireless local area network access point.

5. The method of claim 4, wherein the occupation status of various channels is obtained by scanning the surrounding channels with a wireless local area network card.

6. The method of claim 4, wherein the number of sub-channels in each channel is set according to a demand.
